(19) United States
(12) Patent Application Publication
(10) Pub. No.: US 2003/0137827 A1
(43) Pub. Date: Jul. 24, 2003

(54) Dispenser apparatus including integral glow stick

(76) Inventors: Matthew Bouton, Staten Island, NY (US); Kenneth Jones, Wayne, NJ (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/345,912

(22) Filed: Jan. 16, 2003

Related U.S. Application Data
(60) Provisional application No. 60/351,304, filed on Jan. 21, 2002.

(51) Int. Cl. F21K 2/00

(52) U.S. Cl. 362/34; 362/84

(57) ABSTRACT

An apparatus includes a light source module configured to be disposed within a dispensing container, such as a bottle for dispensing liquid, and configured to contain a chemiluminescent light source, such as a glowstick module, disposed therein. The apparatus is configured to activate the glowstick module by compressing same upon opening the container. For example, the glowstick module may be activated by twisting a cap on a water bottle. Compression of the glowstick module is accomplished via rotational displacement between conformably helix-shaped cams being translating into linear displacement of the glowstick module into a narrowing channel, thus compressing the glowstick module. Components of the apparatus disposed within the dispensing container are configured to cooperate with and fit in existing dispensing container configurations (e.g., water bottles, soda bottles, juice bottles). The chemicals within the glowstick module and the light source module are segregated from the liquid in the dispensing container.

### CROSS REFERENCE TO RELATED APPLICATION

The present application claims priority to U.S. Provisional Application Serial No. 60/351,304 filed Jan. 21, 2002, entitled “Dispenser Apparatus Including Integral Glow Stick”, the entirety of which is hereby incorporated by reference herein.

### FIELD OF THE INVENTION

This present invention generally relates to a dispenser apparatus, and particularly to a dispensing container for dispensing liquid comprising illumination means.

### BACKGROUND

Previous systems have utilized electrical means to provide illumination of liquid in a drinking glass or container. See for example U.S. Pat. No. 6,254,247, issued to Carson and U.S. Pat. No. 6,203,170, issued to Patrick et al. However, systems requiring electrically power suffer disadvantages associated with cost, weight, battery replacement, on/off switching means, and disposal, for example.

Other systems have utilized chemiluminescent light sources. See for example, U.S. Pat. No. 5,609,409, issued to Diehl, U.S. Pat. No. 5,171,081, issued to Pita et al., U.S. Pat. No. 5,671,998, issued to Collet, U.S. Pat. No. 4,563,726, issued to Newcomb et al., U.S. Pat. No. 6,062,380, issued to Domey, U.S. Pat. No. 3,584,211, issued to Rauhut. However, these systems suffer various disadvantages associated with activating the chemiluminescent light source, such as taking deliberate steps, not associated with using the container/glass, to activate the chemiluminescent light source.

An improved container having a chemiluminescent light source is desired.

### SUMMARY

An apparatus includes a light source module configured to be disposed within a dispensing container. The light source module is configured to contain a chemiluminescent light source therein, and the apparatus is configured to activate the chemiluminescent light source upon opening the dispensing container.

### BRIEF DESCRIPTION OF THE DRAWINGS

In the drawings:

FIG. 1A is an exploded view of a dispenser apparatus according to a first exemplary embodiment of the present invention;

FIG. 1B is another exploded view of a dispenser apparatus according to the first exemplary embodiment of the present invention.

FIG. 2A is a cross-sectional view of an assembled configuration of the dispenser apparatus in accordance with the first exemplary embodiment of the present invention;

FIG. 2B an isometric partial cross-sectional view of an assembled configuration of the dispenser apparatus in accordance with the first exemplary embodiment of the present invention;

FIG. 2C is another isometric partial cross-sectional view of an assembled configuration of the dispenser apparatus in accordance with the first exemplary embodiment of the present invention;

FIG. 3A is a first illustrative view of a birdcage-like support structure in accordance with a first exemplary embodiment of the present invention;

FIG. 3B is a second illustrative view of a birdcage-like support structure in accordance with a first exemplary embodiment of the present invention;

FIG. 3C is a third illustrative view of a birdcage-like support structure in accordance with a first exemplary embodiment of the present invention;

FIG. 3D is a fourth illustrative view of a birdcage-like support structure in accordance with a first exemplary embodiment of the present invention;

FIG. 3E is an isometric view of a birdcage-like support structure in accordance with a first exemplary embodiment of the present invention;

FIG. 4A is an illustration of a light source module in accordance with a first exemplary embodiment of the present invention;

FIG. 4B is a partial cross-sectional view of a light source module having a light source disposed therein in accordance with a first exemplary embodiment of the present invention;

FIG. 4C is an isometric view of a light source module in accordance with a first exemplary embodiment of the present invention;

FIG. 4D is an enlarged isometric view of a first end of the of a light source module shown in FIG. 4C;

FIG. 4E is an isometric partial cross-sectional view of a chemiluminescent light source disposed within a light source module in accordance with a first exemplary embodiment of the present invention;

FIG. 4F is another isometric partial cross-sectional view of a chemiluminescent light source disposed with a light source module in accordance with a first exemplary embodiment of the present invention;

FIG. 5A is a first view of a container cap in accordance with a first exemplary embodiment of the present invention;

FIG. 5B is a second view of a container cap in accordance with a first exemplary embodiment of the present invention;

FIG. 5C is a third view of a container cap in accordance with a first exemplary embodiment of the present invention;

FIG. 5D is an isometric view of the container cap shown in FIGS. 5A-5C;

FIG. 6A is a cross-sectional view of an assembled configuration of an apparatus in an unopened state in accordance with a first exemplary embodiment of the present invention;

FIG. 6B is a cross-sectional view of the assembled configuration of FIG. 6A showing the relationship between restriction portions during an unopened state in accordance with a first exemplary embodiment of the present invention;

FIG. 7A is a cross-sectional view of an assembled configuration of an apparatus in an opened state in accordance with a first exemplary embodiment of the present invention;

FIG. 7B is a cross-sectional view of the assembled configuration of FIG. 7A showing the relationship between restriction portions during an opened state in accordance with a first exemplary embodiment of the present invention;

FIG. 8 is another isometric partial cross-sectional view of an assembled configuration of the apparatus in accordance with a first exemplary embodiment of the present invention;

FIG. 9 is an isometric partial cross-sectional view of an assembled configuration of the apparatus in accordance with a first exemplary embodiment of the present invention showing conformably helix-shaped cam portions;

FIG. 10 is an isometric partial cross-sectional view of birdcage-like support structure in accordance with a second exemplary embodiment of the present invention; and

FIG. 11 is a cross-sectional view in detail of the birdcage-like support structure shown in FIG. 10 when inserted in a dispenser apparatus, such as a bottle.

### DETAILED DESCRIPTION

An apparatus in accordance with the present invention comprises a dispensing container, such as a bottle for dispensing liquid, and a module configured to contain a chemiluminescent light source, such as a glowstick module, disposed therein. The apparatus is configured to activate the glowstick module upon opening the container. For example, the glowstick module may be activated by twisting a cap attached to a bottle containing a liquid, such as spring water. Upon activation, chemicals within the glowstick module combine with chemicals surrounding the glowstick module causing emission of visible light. As described in greater detail below, rotational displacement between conformably helix-shaped cams formed on an outer surface of a module for containing the chemiluminescent light source and an inner surface of the cap is translated into linear displacement between the module and a narrowing support structure, which responsively compresses and activities the chemiluminescent light source, thus emitting visible light. This visible light is transmitted through the outer surface of the dispensing container, providing a dispensing container, which appears to glow as if turned on by opening the container. This apparatus is particularly applicable to situations wherein the ambient lighting is reduced (e.g., at concerts, parties, movie theaters, homes), although not limited thereto. Example uses of this apparatus include promotional, advertising, and/or personal enjoyment purposes. Components of the apparatus disposed within the dispensing container are configured to cooperate with and fit in existing dispensing container configurations (e.g., water bottles, soda bottles, juice bottles). The chemicals within the glowstick module and the surrounding chemicals are segregated from the liquid in the dispensing container, thus allowing consumption of the liquid without concern for the liquid being contaminated by the chemicals within the glowstick module. Furthermore, the apparatus is configured to prevent the glowstick module and/or other components of the apparatus from exiting the dispensing container when the liquid is being consumed. Thus, the liquid contained within the container may be consumed without concern for swallowing any components of the apparatus. Thus, an apparatus in accordance with the present invention provides a means for activating a light source disposed within a dispensing container by simply accomplishing steps to open the container to consume the liquid. No additional steps are needed to activate the light source (e.g., toggling a designated switch, pulling a tab, inserting a battery).

In this description, relative terms such as “horizontal,” “vertical,” “up,” “down,” “top,” “bottom,” “back,” and “front” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

As described above, a dispenser apparatus in accordance with the present invention comprises means to activate a chemiluminescent light source. Chemiluminescent light sources, also referred to as glowstick modules or lightsticks, are known in the art. For example, one such device is a chemiluminescent light source made by American Cyanamid Company and sold under the trademark CYALUME. Chemiluminescence is typically produced by the reaction of an activator with a fluorescent agent and an oxalate. The chemiluminescent light source is activated by deforming the chemiluminescent light source, such as by bending the chemiluminescent light source, compressing the chemiluminescent light source, or a combination thereof. Deformation of the chemiluminescent light source causes a breakable inner tube or compartment disposed therein to fracture and thus mix the component chemicals, resulting in the emission of visible light via chemiluminescence. It is to be understood, however, that a dispensing apparatus in accordance with the present invention is not limited to the above described means for achieving chemiluminescence, rather any appropriate means for achieving chemiluminescence compatible with a dispensing container in accordance with the present invention is applicable.

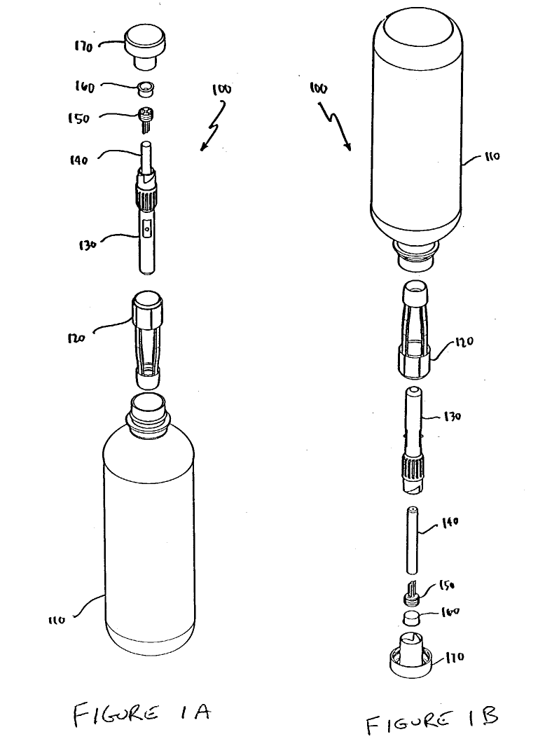

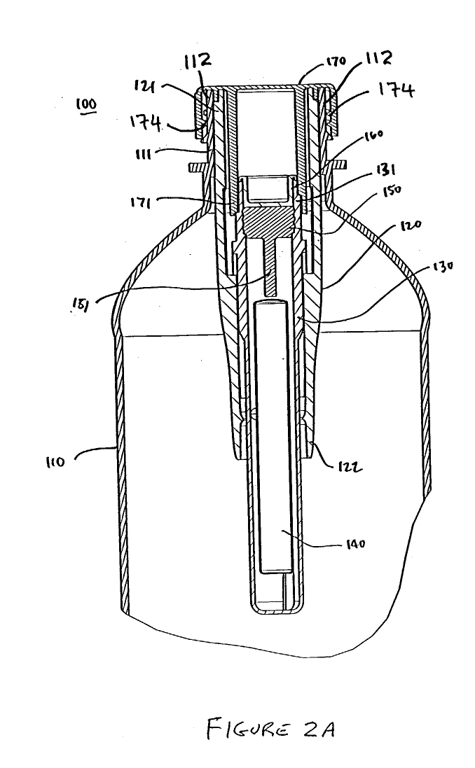

Referring now to FIGS. 1A and 1B, there are shown exploded views of a dispenser apparatus 100 according to a first exemplary embodiment of the present invention. The dispenser apparatus 100 comprises a dispensing container (e.g., bottle) 110 for retaining a quantity of liquid, a birdcage-like support structure 120, a light source module 130, a first module cap 150, a second module cap 160, and a container cap 170. The light source module 130 is configured to have disposed therein a chemiluminescent light source (e.g., glowstick module) 140. The light source module 130 also contains therein a liquid, which when mixed with the liquid within the glowstick module 140 forms a chemiluminescent light source.

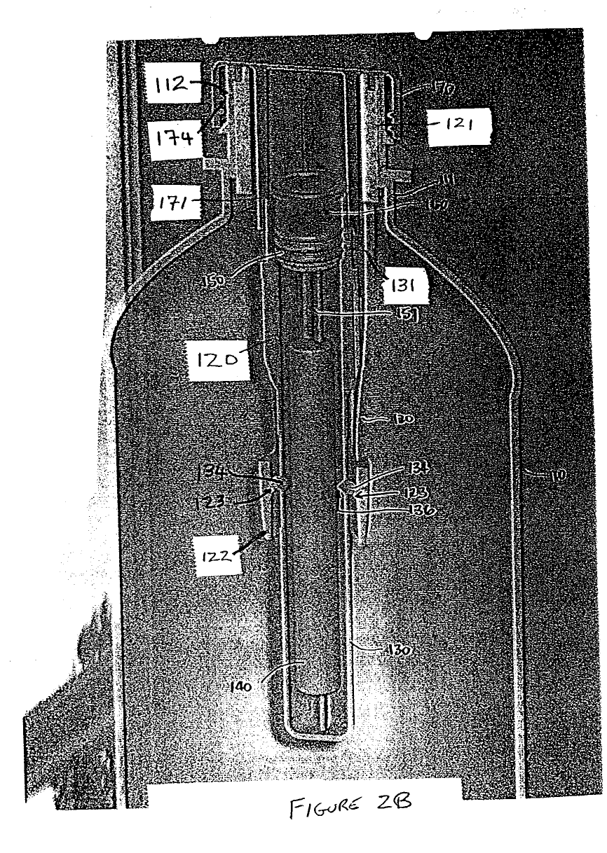

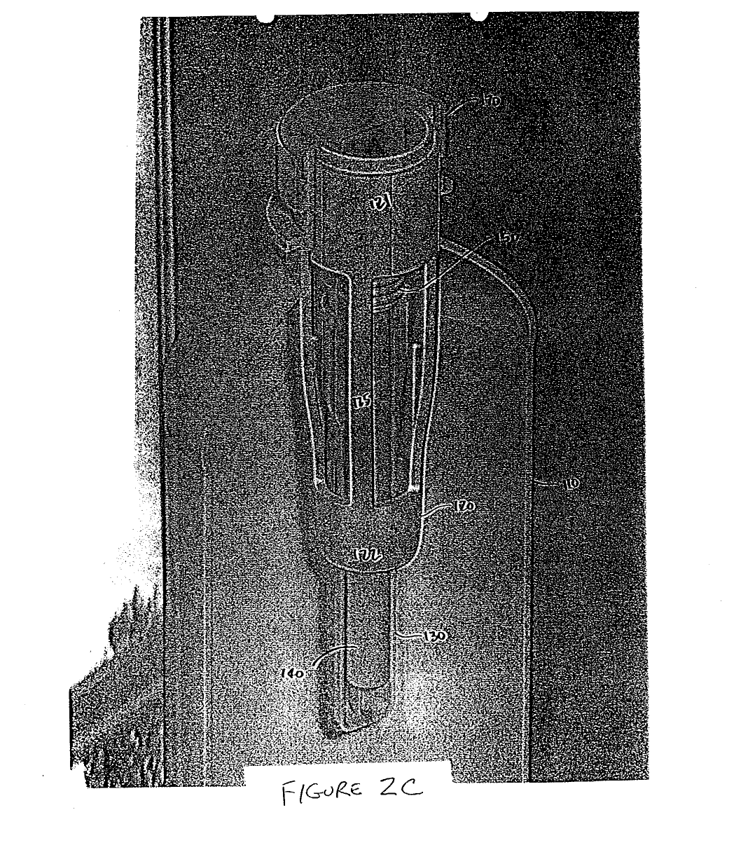

FIG. 2A is a cross-sectional view, and FIGS. 2B and 2C are isometric partial cross-sectional views, of the dispenser apparatus 100 in an exemplary assembled configuration. In this assembled configuration the support structure 120 is disposed within the container 110, the light source module 130 is disposed within the structure 120, the glowstick module 140 is disposed within the module 130, the first module cap 150 is coupled to and disposed within a first end 131 of the module 130 and positioned adjacent the glowstick module 140, the second module cap 160 is positioned between the first module cap 150 and the container cap 170, and the container cap 170 is rotateably coupled to the container 110.

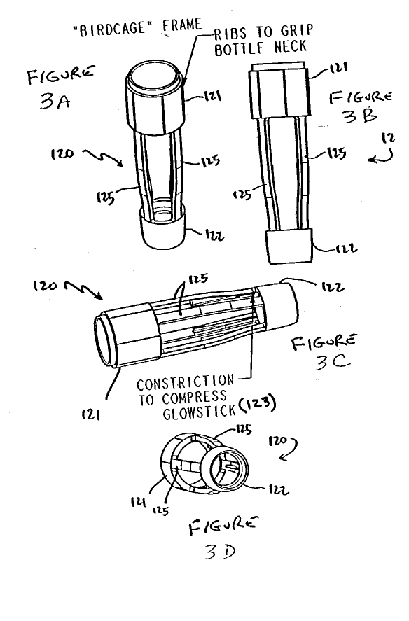

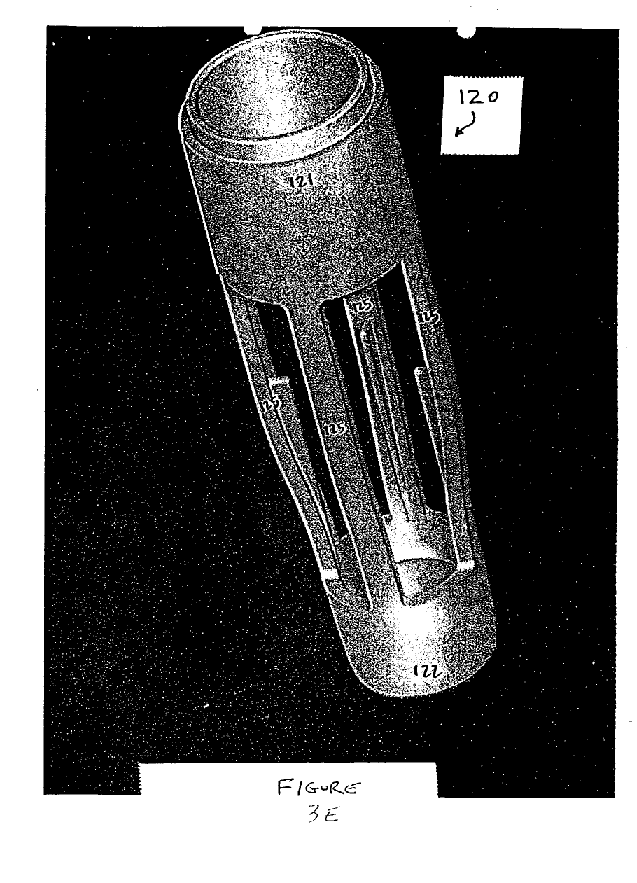

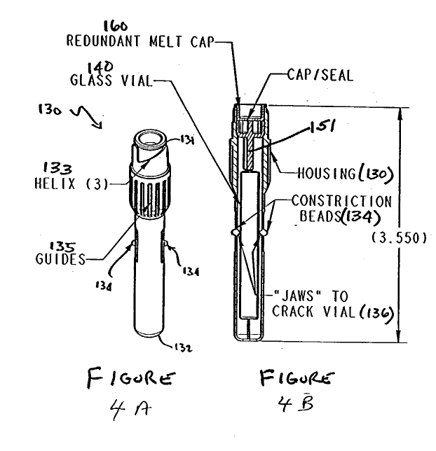

FIGS. 3A and 3B are isometric partial cross-sectional views of the light source (glowstick module) 140 disposed within the light source module 130 in accordance with an embodiment of the present invention. The glowstick module 140 is disposed and secured within the light source module 130. Securing the glowstick module 140 within the light source module 130 prevents the glowstick module 140 from inadvertently being dislodged from the light source module 130. Also, the light source module 130 is sealed to prevent glowstick module and light source module chemicals from leaking out of the light source module 130. In one embodiment, the first module cap 150 comprises at least one bead thereon which ‘snap’ fits into the first end 131 of the light source module 130, thus securing the glowstick module 140 within the light source module 130. The first module cap 150 also includes a shaft member 151 extending therefrom. The shaft member 151 also facilities the securing of the glowstick module 140 within the light source module 130. The second module cap 160 fits into the first end 131 of the light source module 130 above the first module cap 150, and is melted into the light source module, thus sealing the light source module.

The container cap 170 is positioned over a container opening defined by one end of the container (neck 111) to contain (seal) liquid within the container 110. As is well known in the art, the container cap 170 is rotateably coupled to the container. 110 by threadings around an inner surface 174 of the container cap 170 which cooperate with threadings formed on an outer surface 112 of the neck 111 of the container 110 to secure the container cap 170 thereto, for example after the bottle has been filled with a specified liquid (e.g., water, sports drink, soft drink, juice, etc.).

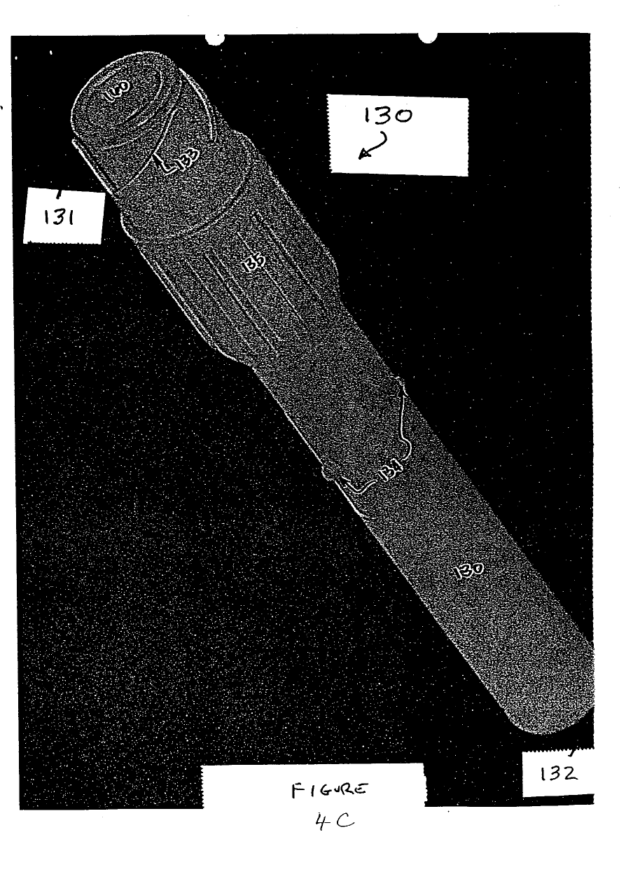

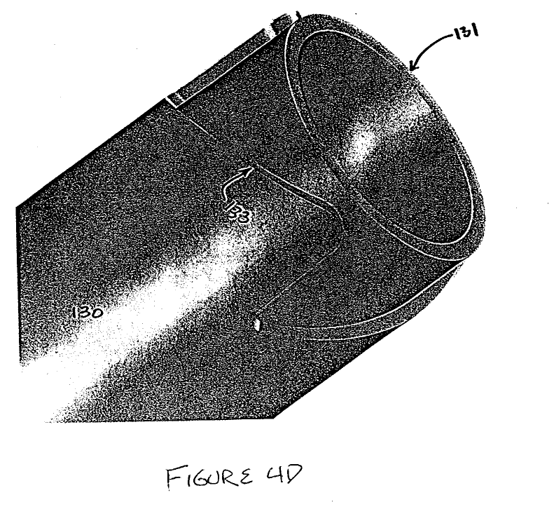

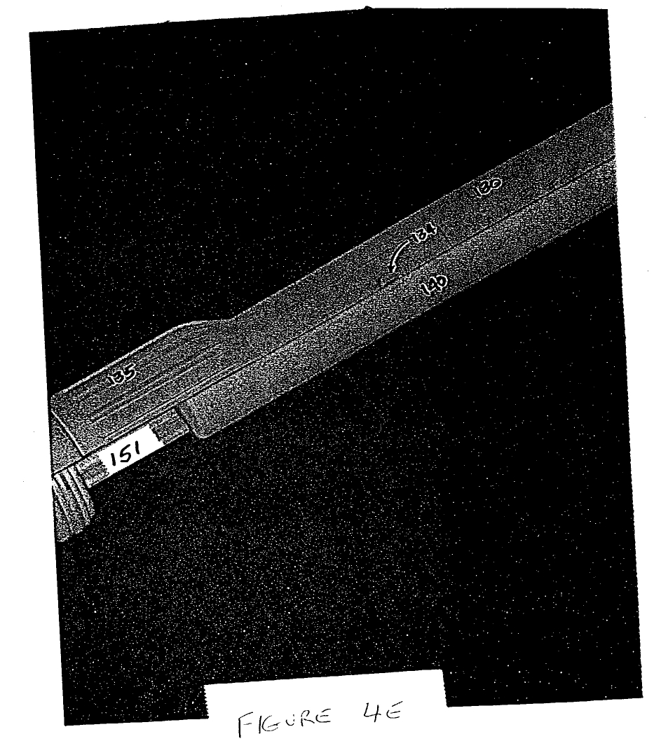

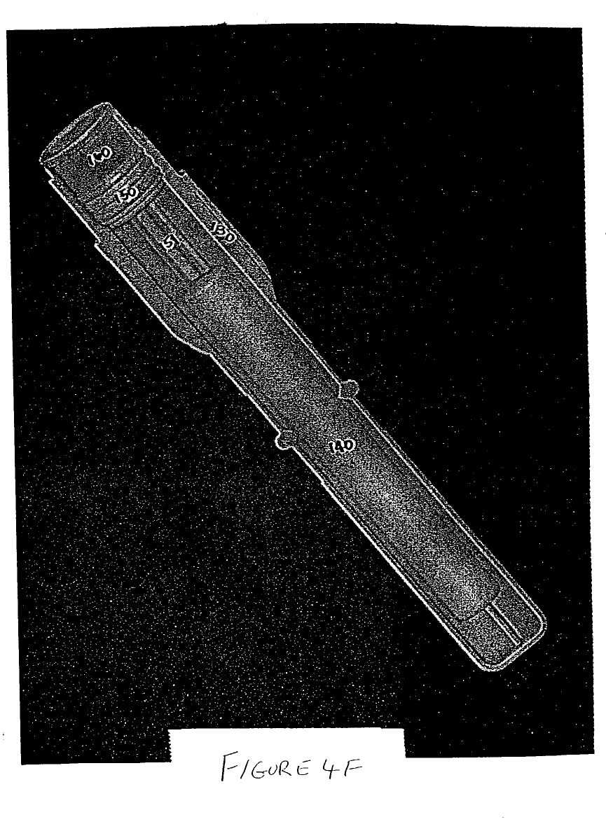

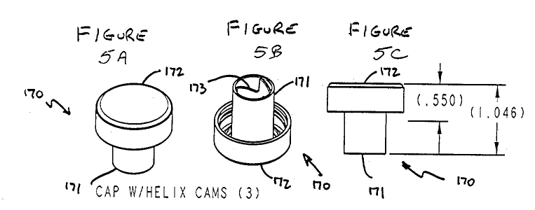

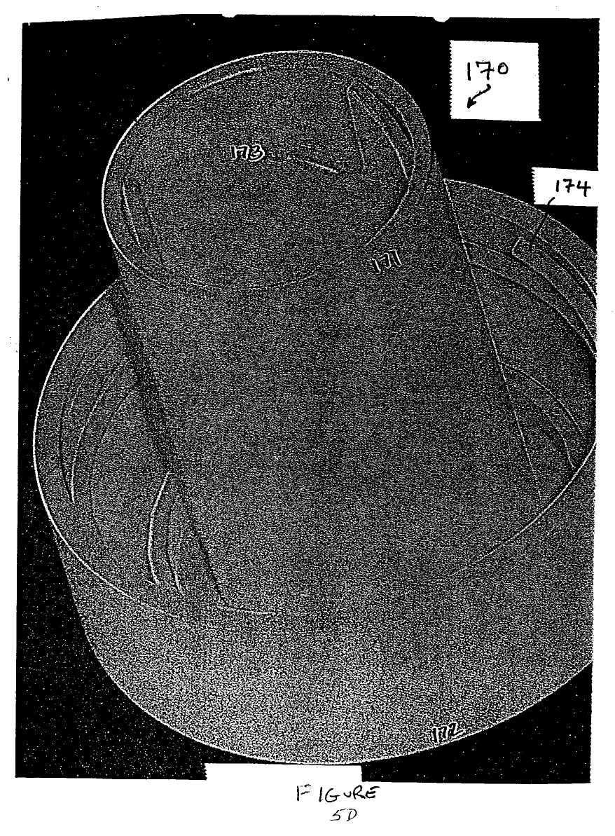

Referring again to FIGS. 2A and 2B, a first end 121 of the birdcage-like support structure 120 rests inside the neck 111 of the container 110. An outer surface of the first end 121 of the birdcage like support structure 120 is coupled to an inner surface of the neck 111 of the container 110 by any appropriate means, such a snap fit, a friction fit, threaded means, or a combination thereof. In an assembled configuration of the apparatus 100, a portion of the light source module 130 extends below a second end 122 of the birdcage structure. Additionally, the first end 131 of the light source module 130 engages a first end 171 of the bottle cap 170. As will be explained in more detail below, the engagement between the first end 131 of the light source module 130 and the first end 171 of the bottle cap 170 is accomplished by means of helix-shaped cams 133 and 173 formed on the both the light source module 130 and the container cap 170 (For example see, FIGS. 4D and 5D).

FIGS. 3A-3D are illustrations of various views, and FIG. 3E is an isometric view of the birdcage-like support structure 120 in accordance with an embodiment of the present invention. As shown in these figures, the birdcage structure 120 includes a first end 121 and a second end 122 connected by struts 125. It will also be noted that the birdcage structure 120 is narrowed towards the second end 122 in order to effectively constrict and break the glowstick module 140. The birdcage-like support structure 120 also include constriction portions 123, which cooperate with constriction portions 134 on light source module 130 (See Figures) to compress the glowstick module 140. Although shown in a birdcage-like configuration, other configurations are envisioned. For example, the support structure 120 may comprise more or less struts 125, the support structure 120 may comprise a continues outer surface (not shown) which is transparent and/or translucent to visible light.

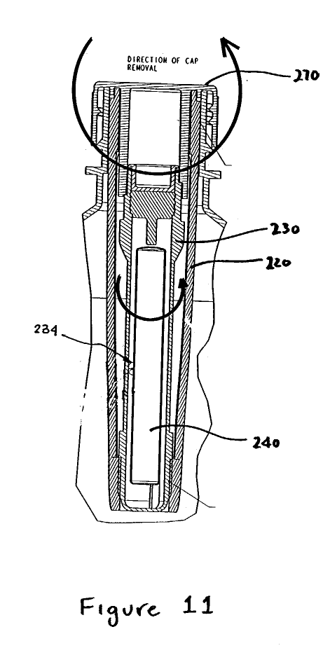

FIGS. 10 and 11 show a second exemplary embodiment of the present invention wherein a birdcage-like support structure 220 and a light source module 230 are configured to perform a ‘ratcheting’ of a glowstick module 240 disposed within the light source module, as apposed to a compression of the glowstick module as described above with reference to FIGS. 1-3. In particular, the light source module 230 includes splines 231 around the periphery of one end which interlock with splines (not numbered) formed on the inner periphery of the same end of the birdcage-like support structure 220. These splines 231 prevent the associated end of the light source module 230 from moving radially within the birdcage-like support structure 220. Thus, when the cap 270 is twisted the upper end of the light source module 230 is twisted, but the lower portion including the splines 231 remains substantially stationary. This action causes the sides of the light source module 230 near the center of the module to compress inward (much like holding one end of the straw and twisting the opposing end causes a central portion of the straw to compress inward), and thus press the constriction bead 234 against the glowstick module 240 and break it. Although the second exemplary embodiment has been described above as including splines on the inner periphery of one end of the birdcage-like support structure 220, such splines are not required by the present invention. The inner periphery of the birdcage-like support structure 220 may be formed to friction fit with the splines 231 of the light source module 230, may include a roughened or knurled surface to grab the splines 231 of the light source module, or may include any other such structure which prevents movement of the associated end of the light source module.

FIG. 4A is a front view, FIG. 4B is a cross-sectional view, and FIG. 4C is an isometric view of the light source module 130 in accordance with the present invention. FIG. 4D is an isometric view of the helix-shaped cams 133 formed on the light source module 130 in accordance with an exemplary embodiment of the invention. FIGS. 4E and 4F are isometric partial cross-sectional views of the chemiluminescent light source 140 disposed within a light source module 130 in accordance with an embodiment of the present invention. As shown in these figures, the light source module 130 includes a first end 131, and a second end 132. Helix-shaped cams 133 are formed around the periphery (outer surface) of the first end 131 of the light source module 130. In the exemplary embodiment shown in FIGS. 4A-4C, three (3) such helix-shaped cams 133 are spaced 120 degrees apart around the periphery of the first end 131, however, it will be noted by those skilled in the art that any number of cams may be placed at any suitable positions around the periphery of the first end 131 depending upon the configuration of the container 110 (e.g., what type and how many threads are disposed on the neck of the container, etc.). The light source module 130 also includes constriction beads 134 for assisting in breaking the glowstick module 140 (e.g., breakable glass vial) as explained above. As shown in FIG. 5B, in an exemplary embodiment, the inner ends of the constriction beads 134 include jaws 136 for biting into the outer surface of the glowstick module 140 and breaking the seal between the reactive chemicals therein. As noted above, the reactive chemicals within the glowstick module 140 mix with reactive chemicals within the light source module 130 to form a chemiluminescent light source. The light source module 130 may also include guides 135 for guiding the glowstick module 140 into the birdcage-like support structure 120 so that the constriction beads 134 line up with the constrictions 123 on the birdcage structure.

FIGS. 5A-5C show various views and FIG. 5D is an isometric view of the container cap 170 in accordance with the present invention. As shown in these figures, the container cap 170 includes a first end 171, and a second end 172, with helix-shaped cams 173 formed around the inner surface of the first end 171 of the container cap 170. In the exemplary embodiment shown in FIGS. 5A-5D, three (3) such helix-shaped cams 173 are spaced 120 degrees apart around the inner surface of the first end 171, however, it will be noted by those skilled in the art that any number of cams may be placed at any suitable positions around the inner surface of the first end 171 depending upon the configuration of the container 110 (e.g., what type and how many threads are disposed on the neck of the bottle, etc.). As discussed above, these helix-shaped cams 173 interact with conformably helix-shaped cams 133 formed on the light source module 130 to force the light source module 130 down in the birdcage-like support structure 120 (and thus activate the interaction of the chemicals in the light source module 130 and the glowstick module 140) when the container cap 170 is twisted off the container 110. It will be noted by those skilled in the art that the container cap 170 may additionally include a tamper evident ring or other tamper protection mechanism to prevent tampering with the container 110 and its contents.

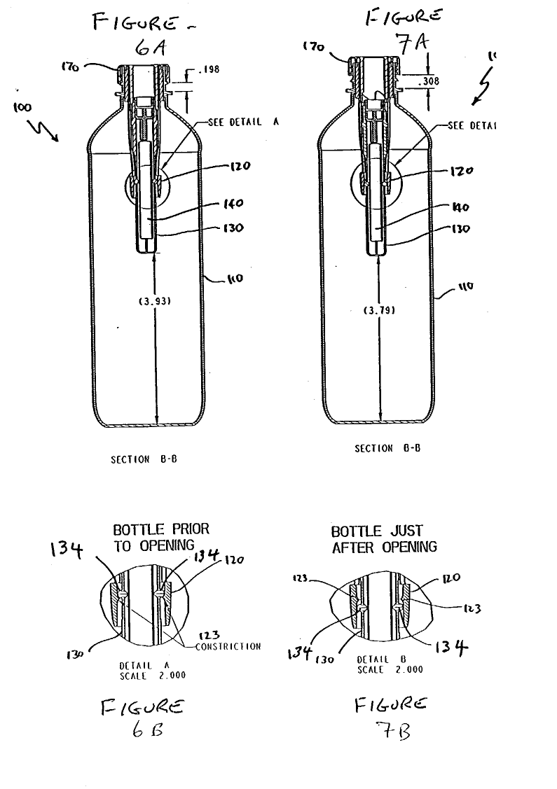

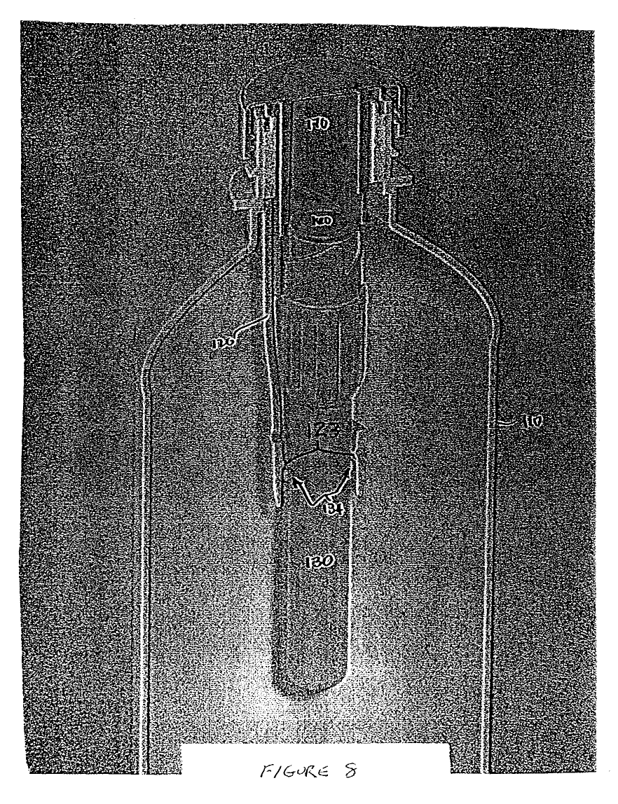

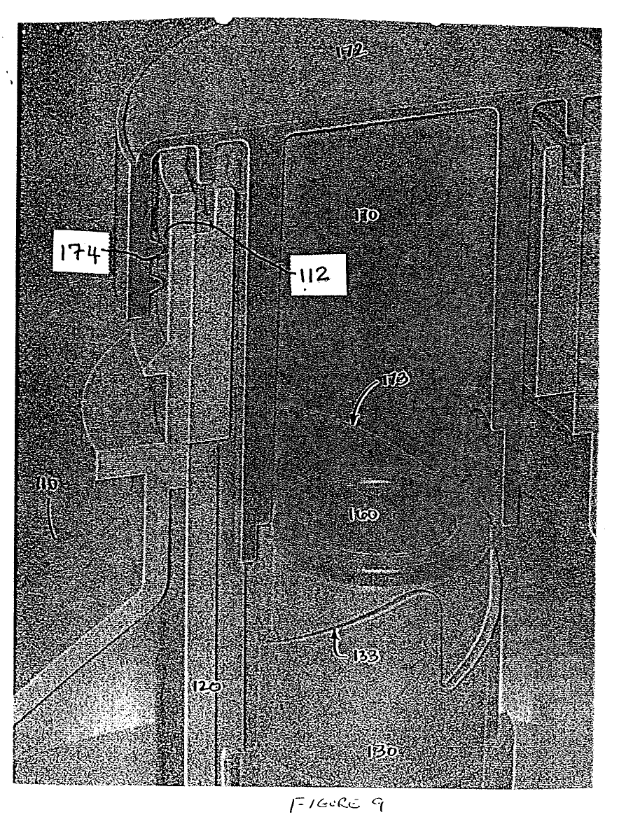

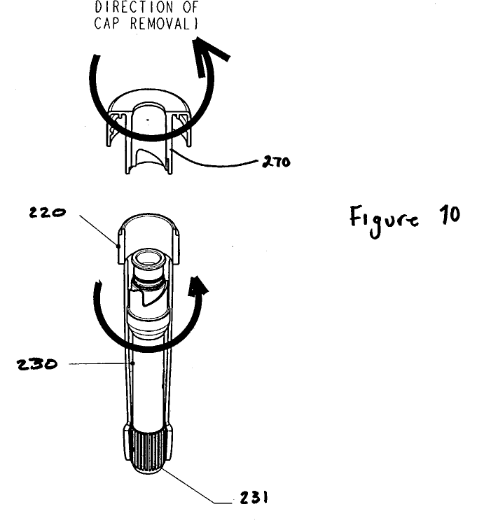

FIGS. 6A and 6B show the dispenser apparatus 100 in a first unopened state. In this state, the container cap 170 has yet to be removed from the container 110, and the glowstick module 140 has yet to be broken (activated). FIGS. 7A and 7B show the dispenser apparatus 100 in a second opened state. In the opened state depicted in FIGS. 7A and 7B, the container cap 170 has been removed from the container 110, and the glowstick module 140 has been broken (activated). FIGS. 8 and 9 are isometric partial cross-sectional views of the apparatus in an assembled configuration. Referring now to FIGS. 7A-10, the light source module 130 includes constriction beads 134 projecting therefrom. These constriction beads 134 cooperate with constrictions 123 formed on the inner surface of the birdcage-like support structure 120 to break (activate by compression) the glowstick module 140 disposed in the light source module 130. In particular, as the container cap 170 is twisted (off), the conformably helix-shaped cams 133 and 173 formed on the light source module 130 and the container cap 170, respectively, interact with one another to force the light source module 130 down in the container 110 and the birdcage-like support structure 120. As the light source module 130 moves downward in the birdcage structure 120 due to this camming, the constriction beads 134 pass over the constrictions 123, thereby causing the sidewalls of the glowstick module 140 to be compressed inward. This compression of the sidewalls of the glowstick module 140 breaks the seal between the chemicals in the glowstick module 140 and the chemicals in the light source module 130, and permits them to mix, thereby generating a glowing substance inside the light source module. Although the drinking of the liquid in the container 110 will sufficiently mix the chemicals in the light source module 130 (once the glowstick module 140 is broken), the user may speed up this process by reapplying the container cap 170 and shaking the bottle. Thus, compression of the glowstick module 140 is accomplished via rotational displacement between conformably helix-shaped cams 133 and 173 being translating into linear displacement of the glowstick module 140 into a narrowing light source module 130, thus compressing and activating the glowstick module.

The constriction beads 134 also prevent the glowstick module 140 from sliding back in the light source module 130 and possibly into the mouth of the user. It will be noted by those skilled in the art that a portion of the sidewalls of the glowstick module 140 may be weakened during manufacture so that they will more easily break under the pressure of the constrictions 123 and constriction beads 134. Additionally, it will be noted that additional (e.g., redundant or varied) constriction portions may be added to the light source module 130 at positions beneath the constriction beads 134 to ensure that the glowstick module 140 does not slide back in the light source module.

Although illustrated and described with reference to certain specific embodiments, the dispenser apparatus including an integral glow stick as described herein is nevertheless not intended to be limited to the details shown. Rather, various modifications may be made in the details within the scope and range of equivalents of the claims and without departing from the spirit of the invention.

1. An apparatus comprising:
a light source module configured to be disposed within a dispensing container, wherein;
said light source module is configured to contain a chemiluminescent light source therein; and
said apparatus is configured to activate said chemiluminescent light source upon opening said dispensing container.

2. An apparatus in accordance with claim 1, further comprising said dispensing container.

3. An apparatus in accordance with claim 1, further comprising said chemiluminescent light source.

4. An apparatus in accordance with claim 1, further comprising:
a support structure positioned with said dispensing container, said light source module being positioned within said support structure; and
a dispensing container cap configured to seal said dispensing container, wherein:
said cap is rotationally coupled to said light source module, and
rotational displacement of said dispensing container cap relative to said light source module results in activation of said chemiluminescent light source.

5. An apparatus in accordance with claim 4, wherein each of said container and said light source module is at least one of transparent and translucent to visible light.

6. An apparatus in accordance with claim 4, wherein said rotational displacement further causes a linear displacement of said light source module relative to said support structure.

7. An apparatus in accordance with claim 6, said light source module and said dispensing container cap comprise conformably helix-shaped cams, wherein:
said linear displacement is responsive to said rotational displacement of said conformably helix-shaped cams;
said chemiluminescent light source is compressed in response to said linear displacement;
said chemiluminescent light source is configured to activate upon compression of said chemiluminescent light source; and
said chemiluminescent light source is activated in response to said linear displacement.

8. An apparatus in accordance with claim 7, said chemiluminescent light source further comprising at least one light source module constriction region projecting outwardly from said chemiluminescent light source module toward said support structure, said support structure comprising at least one support structure restriction region projecting inwardly from said support structure toward said light source module, wherein:
said linear displacement causes said at least one light source module constriction region to cooperate with said at least one support structure constriction region to compress and activate said chemiluminescent light source.

9. An apparatus in accordance with claim 8, wherein said at least one light source constriction region and said at least one module restriction region are configured to restrict said chemiluminescent light source from being displaced in a direction opposite said linear displacement.

10. An apparatus in accordance with claim 1, wherein said container is configured to contain a liquid.

11. A method for illuminating a chemiluminescent light source, said method comprising:
rotationally displacing a dispensing container cap relative to a dispensing container comprising said chemiluminescent light source therein, wherein said cap is rotationally coupled to said container.

12. A method in accordance with claim 11, further comprising:
linearly displacing a light source module relative to a support structure in response to said rotational displacement for activating said chemiluminescent light source, wherein:
said support structure is disposed within said container;
said light source module is disposed within said support structure; and
said chemiluminescent light source is disposed within said light source module.

13. A method in accordance with claim 12, wherein each of said container and said light source module is at least one of transparent and translucent to visible light.

14. A method in accordance with claim 12, further comprising:
compressing said chemiluminescent light source in response to said linear displacement.

15. A method in accordance with claim 14, wherein:
said light source module comprises at least one light source module constriction region projecting outwardly from said light source module toward said light support structure;
said support structure comprises at least one support structure restriction region projecting inwardly from said support structure toward said light source module; and
said chemiluminescent light source is activated in response to said at least one light source module constriction region cooperating with said at least one support structure restriction region in response to said linear displacement to compress said chemiluminescent light source.

16. A container for dispensing liquid, said container comprising:
a container portion configured to contain a liquid therein, said container portion defining a container opening at one end of said container portion;
a support structure having a first end and a second end, said support structure being disposed within said container portion, wherein:
said first end of said support structure is concentrically disposed within said container opening;
said second end of said support structure is positioned further within said container portion; and
said second end of said support structure is more narrow than said first end of said support structure;
a light source module disposed within said support structure, wherein:
said light source module comprises a first end and a second end;
said first end of said light source module is concentrically disposed within said first end of said support structure;
said second end of said light source module is concentrically disposed within said second end of said support structure; and
said light source module comprises at least one helix-shaped cam formed on an outer surface of said first end of said light source module;
a chemiluminescent light source disposed within said light source module, wherein:
said chemiluminescent light source is sealed within said light source module; and
said chemiluminescent light source is configured to activate upon compression of said chemiluminescent light source; and
a container cap configured to contain liquid within said container, said container cap comprising at least one helix-shaped cam formed on an inner surface of said container cap, wherein:
when said container cap is positioned over said container opening to seal said container, said at least one helix-shaped cam formed on said inner surface of said container cap and said at least one helix-shaped cam formed on said outer surface of said first end of said light source module, are opposingly positioned such that rotational displacement of said container cap relative to said light source module causes a linear displacement of said light source module relative to said support structure in a direction toward said second end of said support structure, resulting in compression of said light source module and said chemiluminescent light source, resulting in activation of said chemiluminescent light source.

17. A container in accordance with claim 16, wherein:
said light source module comprises at least one light source module constriction region projecting outwardly from said light source module toward said support structure;
said support structure comprises at least one support structure constriction region projecting inwardly toward said light source module; and
said linear displacement causes said at least one light source module constriction region to cooperate with said at least one support structure restriction region to compress and activate said chemiluminescent light source.

18. An apparatus in accordance with claim 4, wherein the support structure includes an inner module and an outer module.

19. An apparatus in accordance with claim 18, wherein the inner module includes splines formed at one end thereof.

20. An apparatus in accordance with claim 19, wherein the splines substantially prevent movement of the end of the inner module.
